(19) United States
(12) Patent Application Publication
(10) Pub. No.: US 2012/0062482 A1
(43) Pub. Date: Mar. 15, 2012

(54) METHOD OF SCANNING TOUCH ON TOUCH SCREEN

(75) Inventors: Xiaoliang DING, Shanghai (CN); Yue CHEN, Shanghai (CN); Lihua WANG, Shanghai (CN)

(73) Assignee: SHANGHAI TIANMA MICRO-ELECTRONICS CO., LTD., Shanghai (CN)

(21) Appl. No.: 13/038,922

(22) Filed: Mar. 2, 2011

(30) Foreign Application Priority Data
Sep. 14, 2010 (CN) 201010288049.3

(51) Int. Cl. G06F 3/041

(52) U.S. Cl. 345/173

(57) ABSTRACT

The present invention discloses a method of scanning a touch on a touch screen, where drive lines and sense lines of the touch screen form a matrix network. The method includes: instructing the touch screen to enter into a standby mode if no touch has been detected for a time that reaches or exceeds a preset time in a working mode of the touch screen; in the standby mode, scanning A drive lines and sensing B sense lines, said A being an integer greater than or equal to 1 and less than M, and said B being an integer greater than or equal to 1 and less than or equal to N, where M is the total number of the drive lines and N is the total number of the sense lines; instructing the touch screen to enter into the working mode if there is a current fluctuation on the sense lines which are sensed in the standby mode; in the working mode, scanning all the drive lines and sensing all the sense lines. The touch screen is instructed to enter into the energy-saving standby mode if no touch has been detected by the time that reaches or exceeds the preset time, thus achieving the purpose of reducing the power consumption of the touch screen.

### FIELD OF THE INVENTION

The present invention generally relates to the electronic technology field, and more particularly to a method of scanning a touch screen.

### BACKGROUND OF THE INVENTION

As an input medium, a touch screen is capable of providing better convenience to users than a keyboard and a mouse. The touch screen may be classified into resistive type, capacitive type, surface acoustic wave type, infrared type and so on according to different realization principles. Nowadays, the touch screens of resistive and capacitive type are widely used.

A touch screen may be used in cooperation with a display screen such as LCD (Liquid Crystal Display) and so on. The cooperation method may be the traditional one of directly sticking the touch screen onto the display screen, or also the recent one of the embedded touch screen which integrates the touch screen together with the display screen, and so on.

In particularly, a capacitive touch screen generally includes drive lines along X direction and sense lines along Y direction. Thus, the drive lines and the sense lines constitute a network to determine the location of a touch point jointly. The specific principle of detection is applying voltage to the drive lines and detecting signal changes on the sense lines. The coordinate in X direction can be determined by the drive lines and the coordinate in Y direction can be determined by the sense lines. During the detection, the drive lines in the X direction are scanned line by line. The signal on each of the sense lines is read when each row of the drive lines is scanned. Through a round of scanning, each of the row-column intersections can be scanned. Thus, X*Y signals need to be scanned all together. In this manner of detection, a number of point coordinates can be determined specifically and therefore multi-touch can be achieved.

The equivalent circuit model of the capacitive touch screen shown in FIG. 1 includes a signal source 101, a drive line resistance 102, a sense line resistance 104, a mutual capacitance 103 between the drive line and the sense line, a detection circuit 105 and further includes a drive line parasitic capacitance 106, a sense line parasitic capacitance 107. When a finger touches the touch screen, a portion of current flows into the finger, which is equivalent to a change of the mutual capacitance between the drive line and the sense line. The resulting weak change of the current can be detected at the detection terminal so that the occurrence of the touch is judged, and the location of the touch point is determined

In the touch detection method described above, the drive lines in the X direction need to be scanned line by line continuously and the signal on the sense lines in the Y direction need to be detected column by column continuously to determine the location of the touch. This scanning could not stopped even no touch occurs (for example, when the display screen is in the standby mode). Therefore, the energy consumption in this scanning manner is high when the display screen is in the standby mode, leading to large power consumption of the touch screen.

### SUMMARY OF THE INVENTION

The purpose of the present invention is to provide a method of scanning a touch on a touch screen to lower the power consumption of scanning a touch on the touch screen.

The present invention provides a method of scanning a touch on a touch screen, where drive lines and sense lines of the touch screen form a matrix network, including:
instructing the touch screen to enter into a standby mode if no touch has been detected for a time that reaches or exceeds a preset time in a working mode of the touch screen; in the standby mode, scanning A drive lines and sensing B sense lines, said A being an integer greater than or equal to 1 and less than M, and said B being an integer greater than or equal to 1 and less than or equal to N, wherein M is the total number of the drive lines and N is the total number of the sense lines; and
instructing the touch screen to enter into the working mode if there is a current fluctuation on the sense lines which are sensed in the standby mode; in the working mode, scanning all the drive lines and sensing all the sense lines.

The present invention also provides a method of scanning a touch on a touch screen, where drive lines and sense lines of the touch screen form a matrix network, including:
instructing the touch screen to enter into a standby mode if no touch has been detected for a time that reaches or exceeds a preset time in a working mode of the touch screen; in the standby mode, scanning A drive lines and sensing B sense lines, said A being an integer greater than or equal to 1 and less than or equal to M, and said B being an integer greater than or equal to 1 and less than N, wherein M is the total number of the drive lines and N is the total number of the sense lines; and
instructing the touch screen to enter into the working mode if there is a current fluctuation on the sense lines which are sensed in the standby mode; in the working mode, scanning all the drive lines and sensing all the sense lines.

In the method of scanning a touch on the touch screen of the present invention, the touch screen is instructed to enter into the energy-saving standby mode when no touch has been detected for a time that reaches or exceeds a preset time, thus achieving the purpose of reducing the power consumption of the touch screen. When detecting an occurrence of touch in the standby mode, the touch screen will be put into the working mode to ensure the normal use of the touch screen.

### BRIEF DESCRIPTION OF THE DRAWINGS

FIG. 1 is a schematic view of an equivalent circuit model of a capacitive touch screen;

FIG. 2 is a schematic view of an arrangement of drive lines and sense lines of a capacitive touch screen;

FIG. 3 is a schematic flowchart of a method for scanning a touch on a touch screen according to the present invention;

FIG. 4 is a schematic view of scanning drive lines in a standby mode according to the present invention; and

FIG. 5 is a schematic view of sensing sense lines in a standby mode according to the present invention.

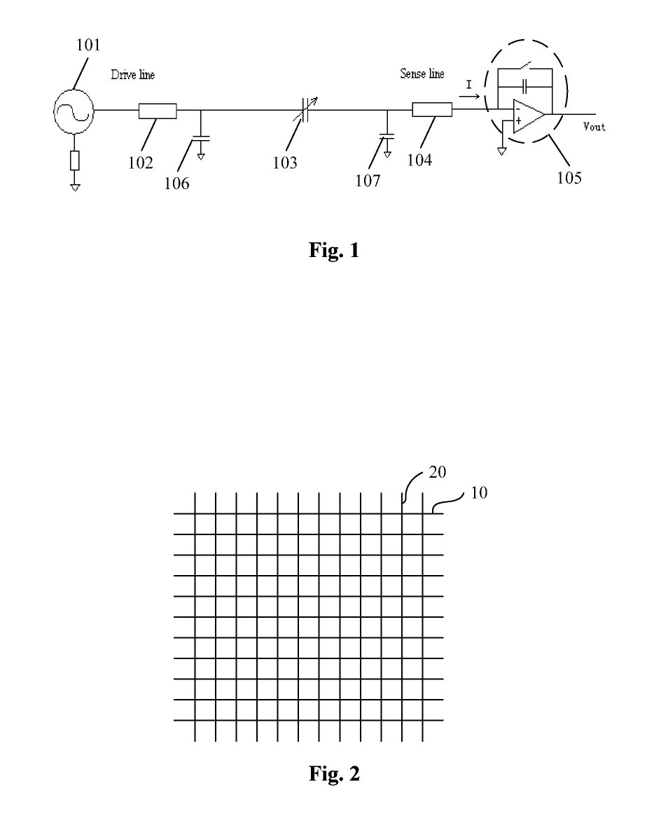

### DETAILED DESCRIPTION OF THE INVENTION

In order that the purpose, features and advantages of the present invention can be more apparent and be better understood, in the following, embodiments of the present invention will be described in further detail in conjunction with the accompanying drawings and the preferred embodiments.

### First Embodiment

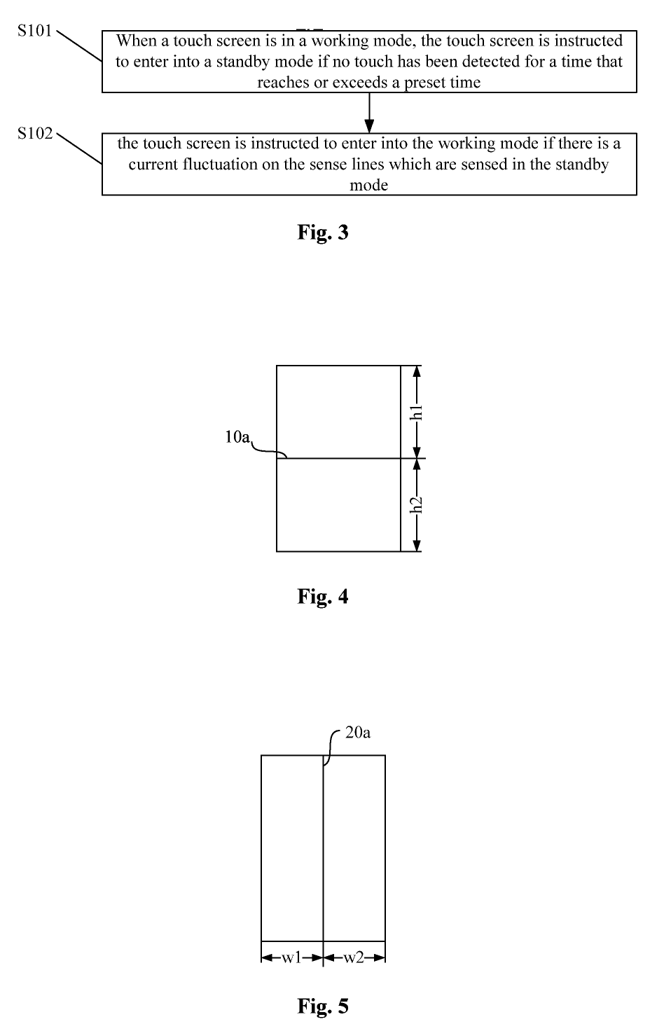

The embodiment provides a method of scanning a touch on a touch screen. As shown in FIG. 2, drive lines 10 and sense lines 20 of the touch screen form a matrix network. Referring to FIG. 3, the method of scanning a touch on the touch screen includes the following steps:

S101, when the touch screen is in a working mode, the touch screen is instructed to enter into a standby mode if no touch has been detected for a time that reaches or exceeds a preset time.

In order to lower the power consumption of the touch screen, the present invention introduces a concept of the standby mode, in which A drive lines are scanned and B sense lines are sensed. Said A is an integer greater than or equal to 1 and less than M, and said B is an integer greater than or equal to 1 and less than or equal to N, where M is the total number of the drive lines and N is the total number of the sense lines. It can be seen that in the standby mode there is at least one drive line of the touch screen not working, so the effect of saving the electrical energy consumption could be achieved compared with in the working mode (i.e. all the drive lines are scanned and all the sense lines are sensed).

The preset time can be 5 s or 10 s or other values. The touch screen and the display screen may enter into the standby mode synchronously or independently (i.e. the display screen is at work while the touch screen is on standby). The preset time may be a default time value configured before a touch screen leaves the factory or be set by users later on their own according to the requirement, which is not be defined by the present invention. Of course, if no touch is detected, the faster the standby mode is entered into, the more power will be saved.

S102, the touch screen is instructed to enter into the working mode if there is a current fluctuation on the sense lines which are sensed in the standby mode.

For a capacitive touch screen, because when a finger touches the touch screen, a portion of current flows to the finger which is equivalent to the change of a mutual capacitance between the drive line and the sense line, the resulting current change may be detected by a detection terminal which connected with the sense line. Even if a touch point is not at the intersection point of the drive line and the sense line, there also is a current fluctuation on the sense line. When locating the touch, the proportion and strength of the current will be calculated to locate the touch point. In the present invention, the current fluctuation detected in the standby mode is used to judge whether the user performs a touch operation, rather than used to locate the touch. When it is judged that the user performs a touch operation, the touch screen is instructed to enter into the working mode.

In the standby mode, A can be 1 and B can be any one of the integers greater than or equal to 1 and less than or equal to N. Alternatively, B can be 1 and A can be an integer greater than or equal to 1 and less than M. The energy consumption due to the operation of 1 drive line or 1 sense line is reduced greatly compared with that due to the operation of all drive lines and all sense lines in the normal working mode.

Preferably, as shown in FIG. 4, when A is 1, the drive line 10a scanned in the standby mode divides the touch screen into two portions as an upper portion and a lower portion, and the difference between the distance h1 from the drive line 10a to the top of the touch screen and the distance h2 from the drive line 10a to the bottom of the touch screen is minimum. In the case of the drive lines being arranged in equal distance, when M is odd and h1 can be equal to h2, then the ((M+1)/2)th drive line is scanned in the standby mode; when M is even and h1 is slightly different from h2, then the (M/2)th or the ((M+2)/2)th drive line is scanned in the standby mode.

Because the longer the distance from the touch detection point is, the smaller the current fluctuation on the sense line is when the touch happens, in order to accurately sense all the touch action on the touch screen in the standby mode, the drive line scanned in the standby mode may be located in the middle of the screen as much as possible to thereby shorten the distance between the touch point and a touch sense point and improve the sensitivity of the touch detection.

Preferably, as shown in FIG. 5, when B is 1, the sense line 20a sensed in the standby mode divides the touch screen into two portions as a left portion and a right portion, and the difference between the distance w1 from the sense line 20a to the left end of the touch screen and the distance w2 from the sense line 20a to the right end of the touch screen is minimum. In the case of the sense lines being arranged in equal distance, when N is odd and w1 can be equal to w2, then the ((N+1)/2)th sense line is sensed in the standby mode; when N is even and w1 is slightly different from w2, then the (N/2)th or the ((N+2)/2)th sense line is sensed in the standby mode.

Alternatively, A can be 1 and B can also be 1 in the standby mode so that there is one touch sense point on the touch screen to achieve the best energy-saving effect.

In the method of scanning a touch on the touch screen according to the embodiment, the touch screen is instructed to enter into the energy-saving standby mode when no touch has been detected for a time that reaches or exceeds a preset time, thus achieving the purpose of reducing the power consumption of the touch screen. When detecting an occurrence of touch in the standby mode, the touch screen will enter into the working mode to ensure the normal use of the touch screen.

### Second Embodiment

The embodiment provides a method of scanning a touch on a touch screen. A difference between the present embodiment and the first embodiment is that in the standby mode, A drive lines are scanned and B sense lines are sensed, where said A is an integer greater than or equal to 1 and less than or equal to M, and said B is an integer greater than or equal to 1 and less than N, where M is a total number of the drive lines and N is a total number of the sense lines.

Because in the standby mode there is at least one sense line of the touch screen not working, it is thereby possible to achieve the effect of saving the electrical energy consumption compared with in the working mode (i.e. all the drive lines are scanned and all the sense lines are sensed).

In the method of scanning a touch on the touch screen of the embodiment, the touch screen is instructed to enter into the energy-saving standby mode when no touch has been detected for a time that reaches or exceeds a preset time, thus achieving the purpose of reducing the power consumption of the touch screen. When detecting an occurrence of touch in the standby mode, the touch screen will enter into the working mode to ensure the normal use of the touch screen.

In the methods described above, all or part of the steps can be done by a related hardware instructed by programs. The hardware can be a touch screen controller and so on. The programs can be stored either in chips which is interactive and cooperative with the touch screen controller or directly in the touch screen controller.

It should be noted that the relationship terminologies such as first and second and the like are only used herein to distinguish an entity or operation from another entity or operation, and it is not necessarily required or implied that there are any actual relationship or order of this kind between those entities and operations. Moreover, the terminologies of ‘comprise’, ‘include’ and any other variants are intended to cover the non-exclusive inclusions so that the processes, methods, articles or equipment including a series of elements not only include those elements but also include other elements that are not listed definitely or the elements inherent in the processes, methods, articles or equipment. In the case of no more restrictions, the elements defined by the statement ‘include one . . .’ do not exclude that other same elements also exist in the processes, methods, articles or equipment including the elements.

Only the better embodiments of the present invention are described above, which are not intended to define the scope of protection of the present invention. Any changes, equivalent substitution, improvement and so on made within the spirit and principles of the present invention are all contained in the scope of protection of the present invention.

What is claimed is:

1. A method of scanning a touch on a touch screen, wherein drive lines and sense lines of the touch screen form a matrix network, the method comprising:
instructing the touch screen to enter into a standby mode if no touch has been detected for a time that reaches or exceeds a preset time in a working mode of the touch screen; in the standby mode, scanning A drive lines and sensing B sense lines, said A being an integer greater than or equal to 1 and less than M, and said B being an integer greater than or equal to 1 and less than or equal to N, wherein M is the total number of the drive lines and N is the total number of the sense lines; and
instructing the touch screen to enter into the working mode if there is a current fluctuation on the sense lines which are sensed in the standby mode; in the working mode, scanning all the drive lines and sensing all the sense lines.

2. The method according to claim 1, wherein A is 1 in the standby mode.

3. The method according to claim 1, wherein B is 1 in the standby mode.

4. The method according to claim 1, wherein A is 1 and B is 1 in the standby mode.

5. The method according to claim 2, wherein the drive line scanned in the standby mode divides the touch screen into two portions as an upper portion and a lower portion, and the difference between the distance from the drive line to the top of the touch screen and the distance from the drive line to the bottom of the touch screen is minimum.

6. The method according to claim 4, wherein the drive line scanned in the standby mode divides the touch screen into two portions as an upper portion and a lower portion, and the difference between the distance from the drive line to the top of the touch screen and the distance from the drive line to the bottom of the touch screen is minimum.

7. The method according to claim 3, wherein the sense line sensed in the standby mode divides the touch screen into two portions as a left portion and a right portion, and the difference between the distance from the sense line to the left end of the touch screen and the distance from the sense line to the right end of the touch screen is minimum.

8. The method according to claim 4, wherein the sense line sensed in the standby mode divides the touch screen into two portions as a left portion and a right portion, and the difference between the distance from the sense line to the left end of the touch screen and the distance from the sense line to the right end of the touch screen is minimum.

9. A method of scanning a touch on a touch screen, wherein drive lines and sense lines of the touch screen form a matrix network, the method comprising:
instructing the touch screen to enter into a standby mode if no touch has been detected for a time that reaches or exceeds a preset time in a working mode of the touch screen; in the standby mode, scanning A drive lines and sensing B sense lines, said A being an integer greater than or equal to 1 and less than or equal to M, and said B being an integer greater than or equal to 1 and less than N, wherein M is the total number of the drive lines and N is the total number of the sense lines; and
instructing the touch screen to enter into the working mode if there is a current fluctuation on the sense lines which are sensed in the standby mode; in the working mode, scanning all the drive lines and sensing all the sense lines.

10. The method according to claim 9, wherein A is 1 in the standby mode.

11. The method according to claim 9, wherein B is 1 in the standby mode.

12. The method according to claim 9, wherein A is 1 and B is 1 in the standby mode.

13. The method according to claim 10, wherein the drive line scanned in the standby mode divides the touch screen into two portions as an upper portion and a lower portion, and the difference between the distance from the drive line to the top of the touch screen and the distance from the drive line to the bottom of the touch screen is minimum.

14. The method according to claim 12, wherein the drive line scanned in the standby mode divides the touch screen into two portions as an upper portion and a lower portion, and the difference between the distance from the drive line to the top of the touch screen and the distance from the drive line to the bottom of the touch screen is minimum.

15. The method according to claim 11, wherein the sense line sensed in the standby mode divides the touch screen into two portions as a left portion and a right portion, and the difference between the distance from the sense line to the left end of the touch screen and the distance from the sense line to the right end of the touch screen is minimum.

16. The method according to claim 12, wherein the sense line sensed in the standby mode divides the touch screen into two portions as a left portion and a right portion, and the difference between the distance from the sense line to the left end of the touch screen and the distance from the sense line to the right end of the touch screen is minimum.
